(19) United States
(12) Patent Application Publication
(10) Pub. No.: US 2026/0200504 A1
(43) Pub. Date: Jul. 16, 2026

(54) REMOTE OPERATION ASSISTANCE APPARATUS

(71) Applicant: Mitsubishi Electric Corporation, Tokyo (JP)

(72) Inventors: Kazuyo KAWAKATSU, Tokyo (JP); Kohei TANAKA, Tokyo (JP); Yoshiaki KITAMURA, Tokyo (JP); Tomonori YASUI, Tokyo (JP)

(73) Assignee: Mitsubishi Electric Corporation, Tokyo (JP)

(21) Appl. No.: 19/136,901

(22) PCT Filed: Feb. 15, 2023
(86) PCT No.: PCT/JP2023/005264

§ 371 Date: Jun. 9, 2025

(51) Int. Cl. B60W 60/00; B60W 50/10; B60W 50/14

(52) U.S. Cl. CPC B60W 60/005; B60W 50/10; B60W 50/14; B60W 60/001; B60W 2050/146; B60W 2556/45; B60W 2756/10

(57) ABSTRACT

The present disclosure relates to a remote operation assistance apparatus, including: state detection circuitry detecting surrounding environment information and information of the autonomous operation system; an operation interface receiving input from a remote operator and outputting the input as operation information; state presentation circuitry obtaining the surrounding environment information and the information and presenting to the remote operator; remote operator state recognition circuitry obtaining state information of the remote operator and recognizing a state of the remote operator using the state information and the operation information; display setting dynamic changing circuitry dynamically determining setting of information presented to the remote operator in accordance with the state of the remote operator and outputting the setting as display setting; and failure response supplemental information presentation circuitry displaying supplemental information supplementing determination of the remote operator on a display device based on the display setting.

### TECHNICAL FIELD

The present disclosure relates to a remote operation assistance apparatus, and particularly to a remote operation assistance apparatus assisting a recovery operation of an autonomous operation system when an event in which the autonomous operation cannot be continued by the autonomous operation system which is autonomously operated occurs.

### BACKGROUND ART

When a failure occurs in an autonomous operation system and an autonomous operation is stopped, it is assumed that a remote operator handles a plurality of autonomous operation systems at the same time in a system in which the remote operator determines a factor of the failure and performs a remote operation in a remote location to recover the autonomous operation again.

In such a case, instantaneous grasp of a situation of the plurality of different autonomous operation systems is required of the remote operator; thus, the remote operator has large recognition load. Furthermore, the high-developed autonomous operation system includes a large number of sensors and many types of sensors, and tends to deal with a large amount of data. Thus, it is not easy to grasp surrounding environment information of the autonomous operation system and a situation of the autonomous operation system in consideration of these pieces of information and consider a method for removing a factor of the failure.

Patent Document 1 discloses an operational management system of a computer capable of efficient maintenance and rapid recovery of failure without depending on an individual skill level of a worker.

### PRIOR ART DOCUMENTS

### Patent Document(s)

Patent Document 1: Japanese Patent Application Laid-Open No. 2001-265474

### SUMMARY

### Problem to be Solved by the Invention

Patent Document 1 discloses a technique of displaying a procedure of operational management in a flow chart form on a screen, displaying related information and handling process procedure information, and sequentially displaying information relating thereto as a lower level block, thereby assisting handling of a worker.

However, even when the handling process procedure is indicated, a recognition load of an operator does not decrease, and it is not easy to rapidly grasp a situation and consider countermeasures.

The present disclosure therefore has been made to solve problems as described above, and it is an object to provide a remote operation assistance apparatus capable of reducing a recognition load of a remote operator.

### Means to Solve the Problem

A remote operation assistance apparatus according to the present disclosure is a remote operation assistance apparatus temporarily operating an autonomous operation system which is autonomically operated from a remote location, including: a state detection part detecting surrounding environment information of the autonomous operation system and information of the autonomous operation system; an operation interface receiving input from a remote operator including an intervention operation of remotely controlling the autonomous operation system and outputting the input as operation information; a state presentation part obtaining the surrounding environment information and the information of the autonomous operation system from the state detection part and presenting the surrounding environment information and the information of the autonomous operation system to the remote operator; a remote operator state recognition part obtaining state information of the remote operator and recognizing a state of the remote operator using the state information and the operation information obtained from the operation interface; a display setting dynamic changing part dynamically determining setting of information presented to the remote operator in accordance with the state of the remote operator recognized in the remote operator state recognition part and outputting the setting as display setting; and a failure response supplemental information presentation part displaying supplemental information supplementing determination of the remote operator on a display device based on the display setting obtained from the display setting dynamic changing part.

### Effects of the Invention

According to the remote operation assistance apparatus according to the present disclosure, the setting of the information presented to the remote operator is dynamically determined based on the state of the remote operator and outputted as the display setting, and the failure response supplemental information presentation part displays the supplemental information supplementing the determination of the remote operator on the display device based on the display setting. Thus, a recognition load of the remote operator can be reduced.

### BRIEF DESCRIPTION OF DRAWINGS

FIG. 1 is a flow chart illustrating a flow of an operation of a remote operator operating a remote operation assistance apparatus according to the present disclosure.

FIG. 2 is a block diagram illustrating a configuration of a remote operation assistance apparatus according to an embodiment 1 in the present disclosure.

FIG. 3 is a diagram illustrating an example of a state of a remote operation by a table.

FIG. 4 is a diagram illustrating an example of an accumulation of contents of operations handled in the past by a table.

FIG. 5 is a diagram illustrating an example of a case where information is presented to a remote operator in a flow chart form.

FIG. 6 is a diagram illustrating an example of a case where information is presented to a remote operator in a Yes/No form.

FIG. 7 is a flow chart illustrating an operation of the remote operation assistance apparatus according to the embodiment 1 in the present disclosure.

FIG. 8 is a block diagram illustrating a configuration of a remote operation assistance apparatus according to an embodiment 2 in the present disclosure.

FIG. 9 is a flow chart illustrating an operation of the remote operation assistance apparatus according to the embodiment 2 in the present disclosure.

FIG. 10 is a block diagram illustrating a configuration of a remote operation assistance apparatus according to an embodiment 3 in the present disclosure.

FIG. 11 is a flow chart illustrating an operation of the remote operation assistance apparatus according to the embodiment 3 in the present disclosure.

FIG. 12 is a block diagram illustrating a configuration of a remote operation assistance apparatus according to an embodiment 4 in the present disclosure.

FIG. 13 is a flow chart illustrating an operation of the remote operation assistance apparatus according to the embodiment 4 in the present disclosure.

FIG. 14 is a block diagram illustrating a configuration of the remote operation assistance apparatus according to the embodiment 4 in the present disclosure.

FIG. 15 is a diagram illustrating an example of a state of a remote operation by a table.

FIG. 16 is a flow chart illustrating an operation of the remote operation assistance apparatus according to the embodiment 4 in the present disclosure.

FIG. 17 is a diagram illustrating a hardware configuration achieving the remote operation assistance apparatus according to the embodiments 1 to 5 in the present disclosure.

FIG. 18 is a diagram illustrating a hardware configuration achieving the remote operation assistance apparatus according to the embodiments 1 to 5 in the present disclosure.

### DESCRIPTION OF EMBODIMENT(S)

### Introduction

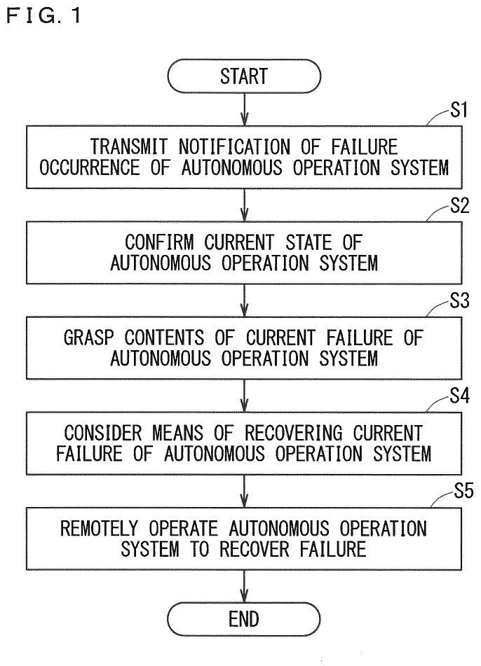

FIG. 1 is a flow chart illustrating a flow of an operation of a remote operator operating a remote operation assistance apparatus according to the present disclosure. A role of the remote operation assistance apparatus according to the present disclosure is described hereinafter using FIG. 1.

In Step S1 illustrated in FIG. 1, notification of failure occurrence is transmitted from an autonomous operation system which is autonomously operated. This notification is transmitted via a monitor device in the autonomous operation system provided separately from the remote operation assistance apparatus, for example.

Upon receiving the notification, the remote operator confirms a current state of an appropriate autonomous operation system via the remote operation assistance apparatus (Step S2).

Next, the remote operator grasps contents of a current failure of the autonomous operation system via the remote operation assistance apparatus (Step S3).

Next, the remote operator considers a recovery means of the current failure of the autonomous operation system using the remote operation assistance apparatus (Step S4).

Finally, the remote operator remotely operates the autonomous operation system based on the recovery means and recoveries the failure (Step S5), and finishes the sequential operation.

Although an automatic drive vehicle is described hereinafter as an example of the autonomous operation system, the autonomous operation system is not limited thereto. An artificial object which is automatically moved such as a flight vehicle, a drone, a probe vehicle, a mobility robot can be an example of the autonomous operation system.

### Embodiment 1

### <Configuration of Apparatus>

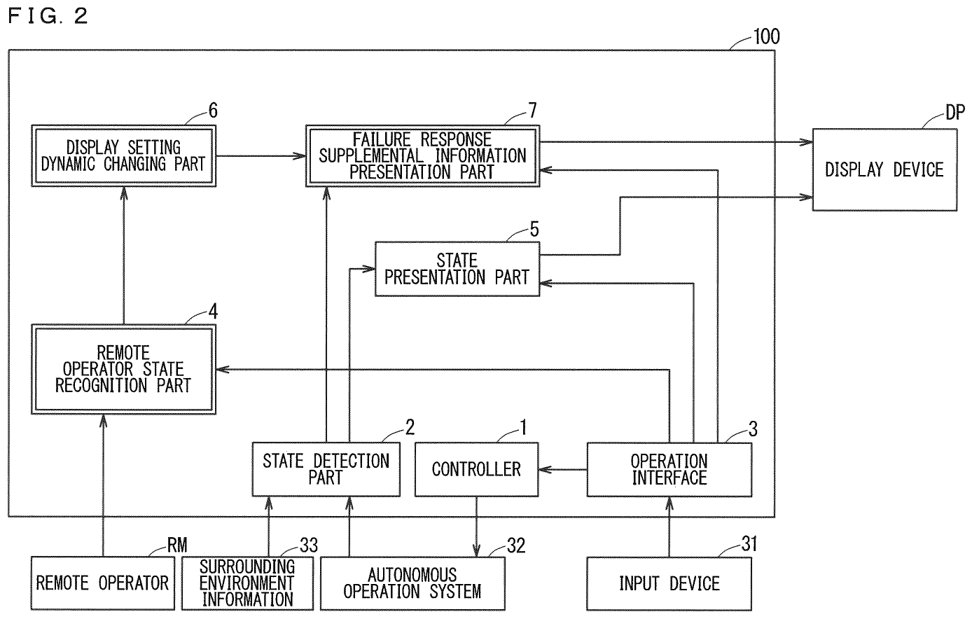

FIG. 2 is a block diagram illustrating a configuration of a remote operation assistance apparatus 100 according to an embodiment 1 in the present disclosure. The remote operation assistance apparatus 100 is used when an autonomous operation system 32 such as an automatic drive vehicle is temporarily controlled from a remote location, and includes a controller 1, a state detection part 2, an operation interface 3, a remote operator state recognition part 4, a state presentation part 5, a display setting dynamic changing part 6, and a failure response supplemental information presentation part 7.

The state detection part 2 detects surrounding environment information 33 of the autonomous operation system 32 and information of the autonomous operation system 32. Examples of the surrounding environment information 33 of the autonomous operation system 32 include road information including a state of a road surface, a state of a travel path such as presence or absence of an obstacle etc. on a travel path, a positional relationship with a pedestrian, a state of the other traffic participant such as a state of a pedestrian, a weather condition such as sunny, rainy, cloudy, or snowy weather, sound in the vicinity, a type of a road, a state of a road surface such as whether or not it is a pavement, presence or absence of a crosswalk, and presence or absence of a traffic light. The surrounding environment information 33 may be information obtained by a plurality of sensors of the autonomous operation system 32 or information obtained from an infrastructure system disposed on a road.

Examples of the information of the autonomous operation system 32 include information determined by the autonomous operation system 32, information of an apparatus and a sensor mounted to the autonomous operation system 32, and information of a state inside a vehicle.

More specifically, examples of the information determined by the autonomous operation system 32 include a determination result of the autonomous operation system 32. Examples of the information of the apparatus and the sensor mounted to the autonomous operation system 32 include a speed, an acceleration rate, the number of rotations of an engine, information of a horn, information of steering, acceleration information, brake information, information of a direction indicator, and positional information. Examples of the information of the state inside the vehicle include information of a state of an occupant in the vehicle and an object such as a luggage located inside the vehicle and environment information of an in-vehicle space such as sound and a temperature.

The surrounding environment information 33 and the information of the autonomous operation system 32 are transmitted to the state presentation part 5 and the failure response supplemental information presentation part 7.

The state presentation part 5 provides the surrounding environment information 33 of the autonomous operation system 32 and the information of the autonomous operation system 32 transmitted from the state detection part 2 to the remote operator via the display device DP. The remote operator sees the display device DP and inputs the intervention operation instruction using an input device 31.

Herein, the remote operator is a person remotely controlling the autonomous operation system 32 from a remote location, thereby recovering an autonomous operation again in accordance with a request from the autonomous operation system 32 and the remote operation assistance apparatus 100 when some failure occurs in the autonomous operation system 32 and the autonomous operation is stopped.

The operation inputted by the remote operator using the input device 31 includes an operation for controlling the remote operation assistance apparatus 100 in addition to the intervention operation of remotely operating the autonomous operation system 32. The operation includes an operation of changing contents of display by the remote operation assistance apparatus 100 for the remote operator to specify a failure factor or grasp a situation of the autonomous operation system 32, for example.

The operation includes communication between staffs and communication between the remote operator and an occupant as the operation by the remote operator other than the intervention operation of remotely controlling the autonomous operation system 32. The communication between the staffs includes an operation for speaking to the other staff such as a maintenance staff of a vehicle or a manager regarding an operation of the autonomous operation system 32, for example, and requesting an operation when a case which cannot be handled by the remote operator occurs. The communication with the occupant includes an operation of talking with the occupant in the autonomous operation system 32, and examples thereof include a case of talking with the occupant when an emergency button is pressed in the autonomous operation system 32.

The operation interface 3 transmits operation information inputted by the remote operator via the input device 31 to the controller 1 and the remote operator state recognition part 4. An operation instruction for changing contents of display by the remote operation visual line apparatus 100 from the operation interface 3 is inputted to the state presentation part 5 and the failure response supplemental information presentation part 7.

The controller 1 receives, via the operation interface 3, the intervention operation instruction for remotely controlling the autonomous operation system 32 in the operation information inputted by the remote operator via the input device 31, and controls the autonomous operation system 32 in accordance with the intervention operation instruction from the remote operator.

The remote operator state recognition part 4 recognizes a state of the remote operator from the operation information of the remote operator and state information of the remote operator obtained from the operation interface 3.

A visual line detection device such as an eye tracker and camera provided to a remote operation room in which the remote operation assistance apparatus 100 is disposed and a heart rate sensor attached to the remote operator, for example, can be used for obtaining the state information of the remote operator. Since the viewpoint information of the remote operator can be obtained from the eye tracker and the camera, the visual line of the remote operator is obtained, and it is detected where the remote operator sees in a screen of the display device DP presenting the information. A technique of detecting the visual line is publicly known, and a visual detection system is installed in a vehicle, for example, to monitor doze of a driver.

Since information of a heart rate of the remote operator can be obtained from the heart rate sensor, a fatigue degree of the remote operator can be estimated from an interval of the heart rate. A technique of estimating the fatigue degree from the heart rate is publicly known, and the fatigue degree of the remote operator can be estimated by comparing an average of heart rates of the remote operator at rest with a heart rate in operation, for example.

The remote operator state recognition part 4 estimates a learning level of the remote operator on the operation and busyness of the operation of the remote operator from the operation of the remote operator for controlling the remote operation assistance apparatus 100 and an intervention operation instruction for remotely controlling the autonomous operation system 32 in the operation information inputted by the remote operator via the input device 31, and creates an operation history. The information obtained from the autonomous operation system 32 can also be used for creating the operation history.

The learning level can be expressed by years of continuous employment, an accumulated operation time, and result of learning and training by a simulator of the remote operator, for example.

The busyness can be expressed by the number of handling per unit time of the remote operator, an activation time as an accumulation of a handling time, and a degree of difficulty of a handling case expressed by an evaluation that a remote operation is difficult or unnecessary, for example.

The operation history is a record of a past operation of the remote operator, and contents of handling operations and positional information of a handling autonomous operation system are recorded, for example.

The remote operator state recognition part 4 can perform recognition from not only the operation information of the remote operator and the state information of the remote operator but can also use state information regarding the remote operator himself/herself inputted by the remote operator. Particularly, when applied is a system that years of continuous employment and a result of learning and training are previously inputted by the remote operator, effective information can be obtained.

The learning level, the busyness, and the fatigue degree can be expressed by stages. For example, a calculated expression of years of continuous employment×X+an accumulated operation time×Y+a result of learning and training×Z=learning level is used regarding the learning level, and a calculation result can be defined in five stages. Herein, each of X, Y, and Z indicates a ratio of importance of each item, and is X=40%, Y=40%, Z=20%, for example. Stages are 0 to 1, 2 to 4, 5 to 7, 8 to 10, and 10 or larger. When the remote operator performs the operation for four hours in one day for twenty days in one month, the accumulated operation time is four hours per day×twenty days×twelve months×ten years=9.6 (thousand hours) in a case where years of continuous employment is ten years. When the result of learning and training is 10, the learning level is 10×40%+9.6×40%+10×20%=9.84, and the stage of learning level is 4.

When the remote operator performs the operation for two hours in one day for twenty days in one month, the accumulated operation time is two hours per day×twenty days×twelve months×ten years=9.6 (thousand hours) in a case where years of continuous employment is twenty years. When the result of learning and training is 10, the learning level is 20×40%+9.6×40%+10×20%=13.84, and the stage of learning level is 5.

The busyness can be expressed by an operation load of the remote operator, and is expressed by “difficulty of handling operation”×“operation time”, for example. In a case where a sum of “difficulty (level of difficulty) of handling operation”×“operation time (minutes)” of the handling operation per unit hour is 0 to 10, the stage of the busyness is set to 1, in a case where there the sum is 11 to 20, the stage of the busyness is 2, in a case where the sum is 21 to 30, the stage of the busyness is set to 3, in a case where the sum is 41 to 50, the stage of the busyness is set to 4, in a case where the sum is 51 or larger, the stage of the busyness is set to 5. For example, in a case where an operation with a level difficulty 2 is performed for five minutes in one hour and an operation with a level difficulty 1 is performed for three minutes, 2×5+1×3=13 is established and a state of busyness is 2.

With regard to the operation history, contents of the operation which has been handled most recently, positional information of the autonomous operation system, and a time for the operation can be expressed by a list form, for example. The operation history can also be calculated as an accumulation of contents of operations handled in the past.

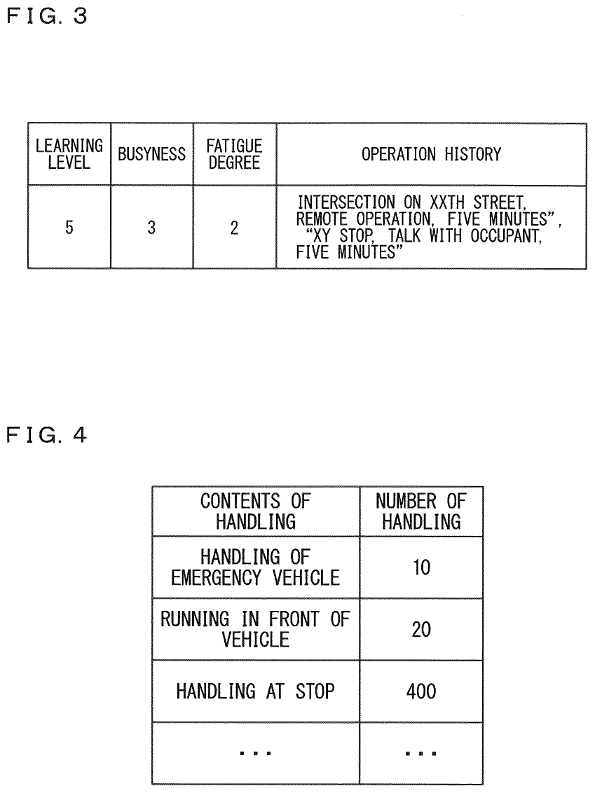

FIG. 3 illustrates an example of a state of a remote operator recognized by the remote operator state recognition part 4 by a table. FIG. 3 illustrates the learning level, the busyness, a fatigue degree, and the operation history. The learning level is 5, the busyness is 3, and the fatigue degree is 2. “Intersection on XX^{th} street, remote operation, five minutes” and “XY stop, talk with occupant, five minutes”, for example, are described as the operation history.

FIG. 4 illustrates an example of an accumulation of contents of operations handled in the past by a table. In FIG. 4, handling of emergency vehicle, pedestrian running in front of vehicle, and handling at stop, for example, are described as contents of handling. The handling of the emergency vehicle is ten times in accumulation, the pedestrian running in front of the vehicle is twenty times in accumulation, and the handling at the stop is four hundred times in accumulation as the number of each handling.

The operation information of the remote operator or a determination result of the autonomous operation system 32 can be used as the contents of operations. As an example of using the determination result of the autonomous operation system 32, when information used in the determination that the autonomous operation system 32 cannot travel by itself such as “defect of recognition of white line on travel path” is applied, “remote operation” needs to be performed as the operation of the remote operator, “remote operation” is set to the content of the operation.

In this case, “determination result of autonomous operation system” and “operation of remote operator” are previously associated, and when “defect of recognition of white line on travel path” is obtained from the autonomous operation system 32, the remote operator state recognition part 4 calculates “remote operation” as the content of the operation. When this method is adopted, the remote operator state recognition part 4 is configured to obtain the determination result of the autonomous operation system 32 via the state detection part 2.

The remote operator state recognition part 4 can also calculate a learning level, busyness, and a fatigue degree by mechanical learning by artificial intelligence (AI) using state information of the remote operator, an operation of the remote operator for controlling the remote operation assistance apparatus 100, and an intervention operation instruction for the remote operator to remotely operating the autonomous operation system 32 as input information. More rapid processing can be achieved by using the AI.

The display setting dynamic changing part 6 dynamically determines setting of a form of information and an amount of information presented to the remote operator via the display device DP based on the state of the remote operator recognized by the remote operator state recognition part 4, that is to say, the learning level, the busyness, and the fatigue degree, and transmits the setting as a display setting to the failure response supplemental information presentation part 7.

Examples of the form of the information include a flow chart form and a form of displaying with a detailed guidance such as a Yes/No form and displaying only a check item to be confirmed.

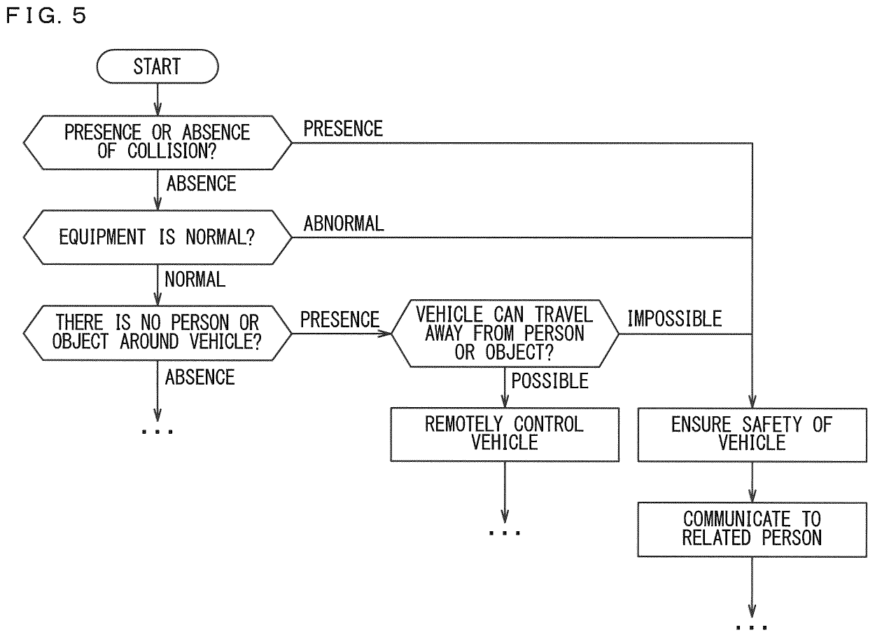

FIG. 5 illustrates an example of a case where information is presented to the remote operator in the flow chart form. In FIG. 5, presence or absence of collision of a vehicle is firstly confirmed, and when there is no collision, it is confirmed whether equipment of the vehicle is normal. When the equipment is normal, the process makes transition to confirmation of presence or absence or a person and an object around the vehicle.

When there is collision in the confirmation of presence or absence of collision of the vehicle, instruction of ensuring safety of the vehicle is transmitted, and then, instruction of communicating to a related person is transmitted.

When the equipment has abnormality in the confirmation of the equipment of the vehicle, instruction of ensuring safety of the vehicle is also transmitted, and then, instruction of communicating to a related person is transmitted.

When there is a person or an object in the confirmation around the vehicle, the process proceeds to confirmation whether the vehicle can travel away from the person or the object, and when the vehicle can, instruction of remotely controlling the vehicle is transmitted, and when the vehicle cannot, instruction of ensuring safety of the vehicle is transmitted. Then, instruction of communicating to the related person is transmitted.

FIG. 5 illustrates only a part of a flow chart for convenience, and the remote operator performs a confirmation operation in accordance with a flow chart displayed on the display device DP, thereby being able to sequentially take necessary measures.

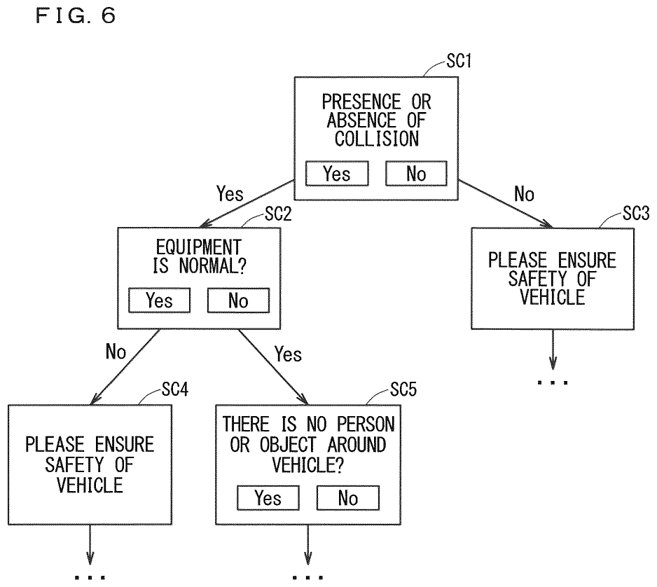

FIG. 6 illustrates an example of a case where information is presented to the remote operator in a Yes/No form. In FIG. 6, a screen SC1 for confirming presence or absence of collision of a vehicle is firstly displayed on the display device DP. When Yes is selected in the screen SC1, the screen makes transition to a screen SC2, and when No is selected, the screen makes transition to a screen SC3. The screen SC3 shows instruction of ensuring the safety of the vehicle.

The screen SC2 is a screen for confirming whether the equipment of the vehicle is normal, and when Yes is selected, the screen makes transition to a screen SC4, and when No is selected, the screen makes transition to a screen SC5.

The screen SC4 shows instruction of ensuring the safety of the vehicle, and the screen SC5 is a screen for confirming presence or absence of a person or an object around the vehicle.

FIG. 6 illustrates only a part of display of the Yes/No form for convenience, and the remote operator performs a confirmation operation in accordance with the display of the Yes/No form displayed on the display device DP, thereby being able to sequentially take necessary measures.

For example, information is presented to the remote operator having a high learning level in the flow chart form, and information is presented to the remote operator having a low learning level in the Yes/No form. Thus, information can be presented in a way which reflects characteristics of each individual remote operator rather than being cumbersome depending on a learning level of the remote operator or unfriendly to the remote operator who are unfamiliar with the system. Thus, information having appropriate contents can be presented at an appropriate information amount, and an error in determination of the remote operator can be reduced.

The amount of information is an information amount of contents for supplement, and an amount of a sentence described in the flow chart described above, for example, is set.

More specifically, setting of a form of information and an amount of information is dynamically changed depending on a state of the remote operator. For example, displayed for a skilled operator is only a check item to be checked at a minimum, and a flow chart with a detailed description is displayed for an unskilled remote operator depending on the learning level. An information amount of description is further adjusted depending on busyness. With regard to the operation history, detailed information is displayed for a location which is handled for a first time, and display is simplified in a case where a similar operation is performed most recently. When a similar operation is sequentially performed on a plurality of systems, display is simplified. However, when the information is partially different, information is added to pay attention to the different part.

The display setting dynamic changing part 6 can also dynamically determine setting of a form of information and an amount of information presented to the remote operator by mechanical learning by AI using a learning level, busyness, and a fatigue degree as a state of the remote operator recognized by the remote operator state recognition part 4 as input information. More rapid processing can be achieved by using the AI.

The failure response supplemental information presentation part 7 creates information supplementing determination of the remote operator, and presents the information together with the information of the state presentation part 5 to the display device DP. That is to say, the form of the information and the amount of information are adjusted based on the display setting obtained from the display setting dynamic changing part 6, and are displayed as supplemental information supplementing the determination of the remote operator.

Information and an operation procedure to be confirmed for the remote operator to specify the failure factor or grasping a situation of the autonomous operation system 32 and information and an operation procedure of the remote operation assistance apparatus 100 to be confirmed regarding handling for recovering the autonomous operation system 32 to an autonomous operation, for example, are created as the supplemental information supplementing the determination of the remote operator.

With regard to the information and the operation procedure of the remote operation assistance apparatus to be confirmed, preset information such as the flow chart form and the Yes/No form described above is used, and particularly, information provided based on an individual event such as a recognition result of the autonomous operation system 32 and the surrounding environment information 33 of the autonomous operation system 32, for example, are uniquely created. For example, when the recognition result of the autonomous operation system 32 is “defect of recognition of white line”, “recognition result of system is “defect of recognition of white line”” is displayed.

In creating supplemental information supplementing determination of the remote operator and creating display contents corresponding to the display setting, the surrounding environment information 33 of the autonomous operation system 32 and the information of the autonomous operation system 32 obtained from the state acquisition part 2 can be used.

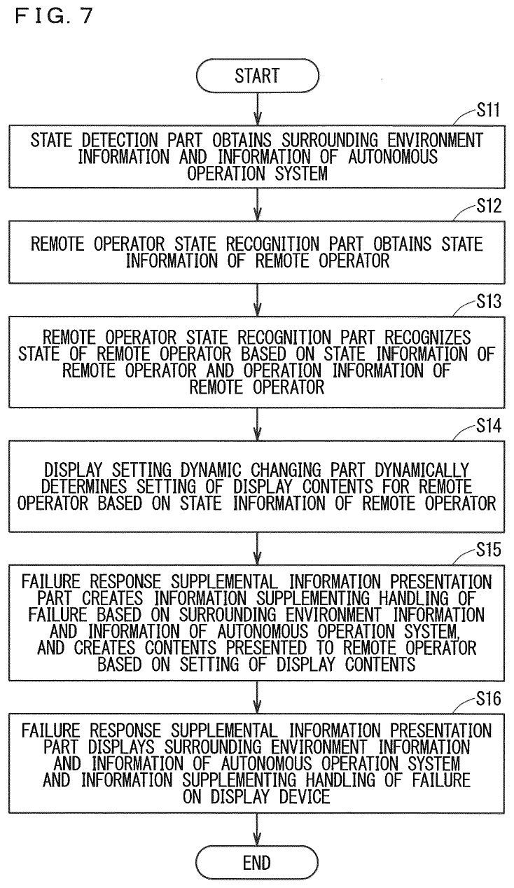

A position of information and a target to be emphatically displayed can also be adjusted in presenting the information to the remote operator.

<Operation>The operation of the remote operation assistance apparatus 100 is described next using a flow chart illustrated in FIG. 7. When the remote operation assistance apparatus 100 is operated, the state detection part 2 firstly obtains the surrounding environment information 33 of the autonomous operation system 32 and information of the autonomous operation system 32 (Step S11).

The remote operator state recognition part 4 obtains the state information of the remote operator (Step S12).

The remote operator state recognition part 4 recognizes the state of the remote operator based on the state information of the remote operator and the operation information of the remote operator (Step S13).

The display setting dynamic changing part 6 dynamically determines the setting of the display contents for the remote operator based on the state information of the remote operator (Step S14).

The failure response supplemental information presentation part 7 creates the information supplementing handling of the failure based on the surrounding environment information 33 of the autonomous operation system 32 and the information of the autonomous operation system 32, and creates the contents presented to the remote operator based on the setting of the display contents determined in the display setting dynamic changing part 6 (Step S15).

The failure response supplemental information presentation part 7 displays the surrounding environment information 33 of the autonomous operation system 32, the information of the autonomous operation system 32, and the information supplementing the handling of the failure on the display device DP, and finishes sequential processes (Step S16).

### <Effect>

As described above, in the remote operation assistance apparatus 100 according to the embodiment 1, the remote operator state recognition part 4 recognizes the state of the remote operator from the operation information of the remote operator and the state information of the remote operator, the display setting dynamic changing part 6 dynamically determines the form of the information and the amount of information presented to the remote operator based on the state of the remote operator recognized in the remote operator state recognition part 4 and creates the display setting, and the failure response supplemental information presentation part 7 presents the display setting to the remote operator as the information supplementing the determination of the remote operator. Thus, a recognition load of the remote operator can be reduced.

### Embodiment 2

### <Configuration of Apparatus>

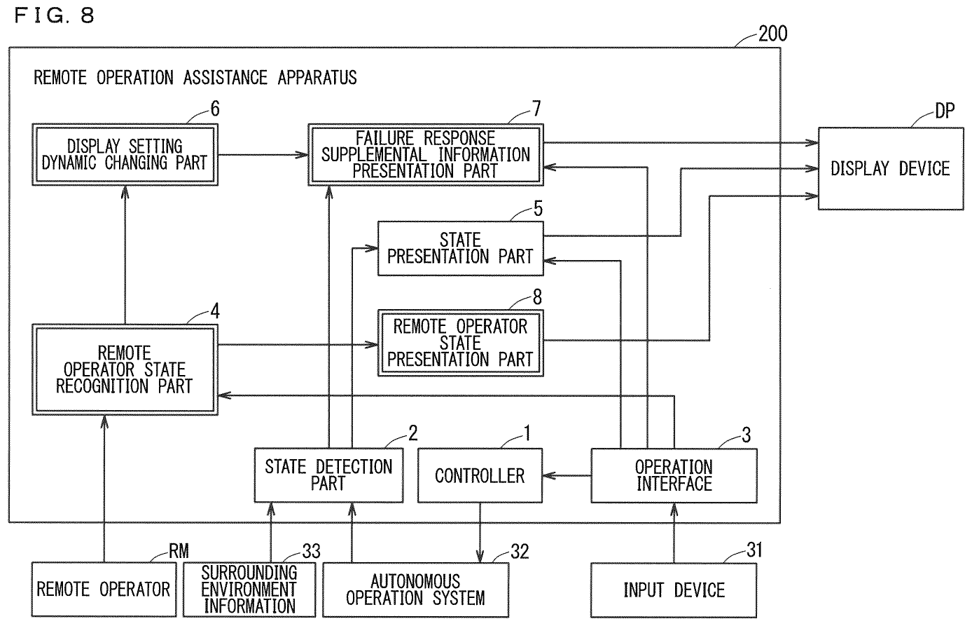

FIG. 8 is a block diagram illustrating a configuration of a remote operation assistance apparatus 200 according to an embodiment 2 in the present disclosure. The remote operation assistance apparatus 200 further includes a remote operator state presentation part 8 displaying the state of the remote operator recognized in the remote operator state recognition part 4 on the display device in addition to the configuration of the remote operation assistance apparatus 100 illustrated in FIG. 2. In FIG. 8, the same reference numerals are assigned to the same configuration as those of the remote operation assistance apparatus 100 described using FIG. 2, and the repetitive description is omitted.

The remote operator state presentation part 8 transmits notification of the state of the remote operator recognized in the remote operator state recognition part 4 to the remote operator, and notifies the remote operator of a purpose of change in dynamically changing the display on the display device DP to reduce strangeness felt by the remote operator when the display is dynamically changed.

That is to say, when the information amount of the display on the display device DP is changed such as a case where a current guidance in a detailed flow chart form is suddenly changed to simple information presentation, there is a possibility that the remote operator wonders why the display has been suddenly changed and gets confused. The same applies to a case where a simple information presentation is changed to a complex information presentation.

Thus, when the purpose of change of the display and the state of the remote operator are combined and displayed, the remote operator can have feeling of conviction regarding change of the display. For example, when notification of “since learning level is improved, guidance is simplified” or “since fatigue degree is high, guidance is shown in detail”, for example, is transmitted to the remote operator, strangeness caused by the sudden change of the display can be reduced.

### <Operation>

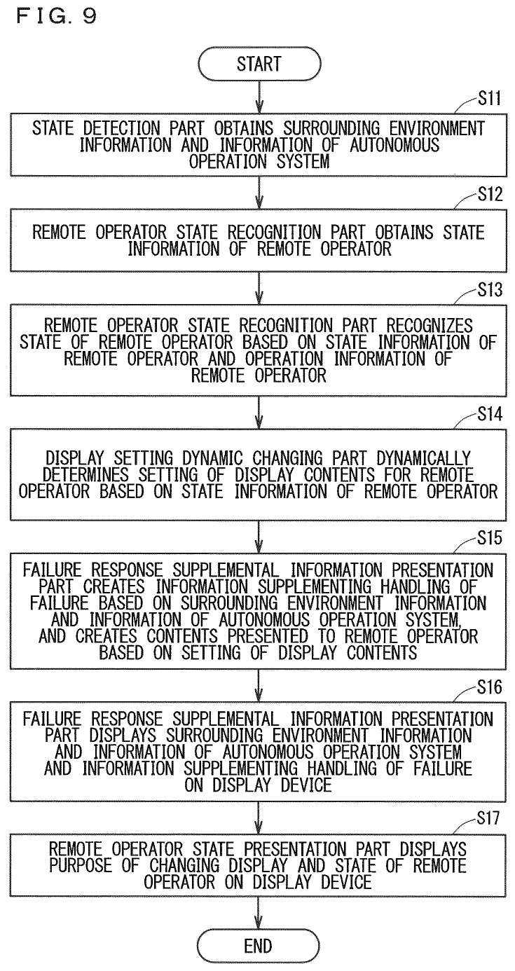

The operation of the remote operation assistance apparatus 200 is described next using a flow chart illustrated in FIG. 9. Steps S11 to S16 in FIG. 9 are the same as Steps S11 to S16 in the flow chart illustrated in FIG. 7; thus, the description is omitted.

In Step S17 subsequent to Step S16 in FIG. 9, the remote operator state presentation part 8 displays the purpose of change of the display and the state of the remote operator on the display device DP, and finishes the sequential processes.

### <Effect>

As described above, in the remote operation assistance apparatus 200 according to the embodiment 2, the remote operator state presentation part 8 combines and displays the purpose of change of the display and the state of the remote operator on the display device DP. Thus, even when the form of the information and the amount of information presented to the remote operator are changed, the remote operator can have feeling of conviction regarding change of the display, and strangeness caused by sudden change of the display can be reduced.

### Embodiment 3

### <Configuration of Apparatus>

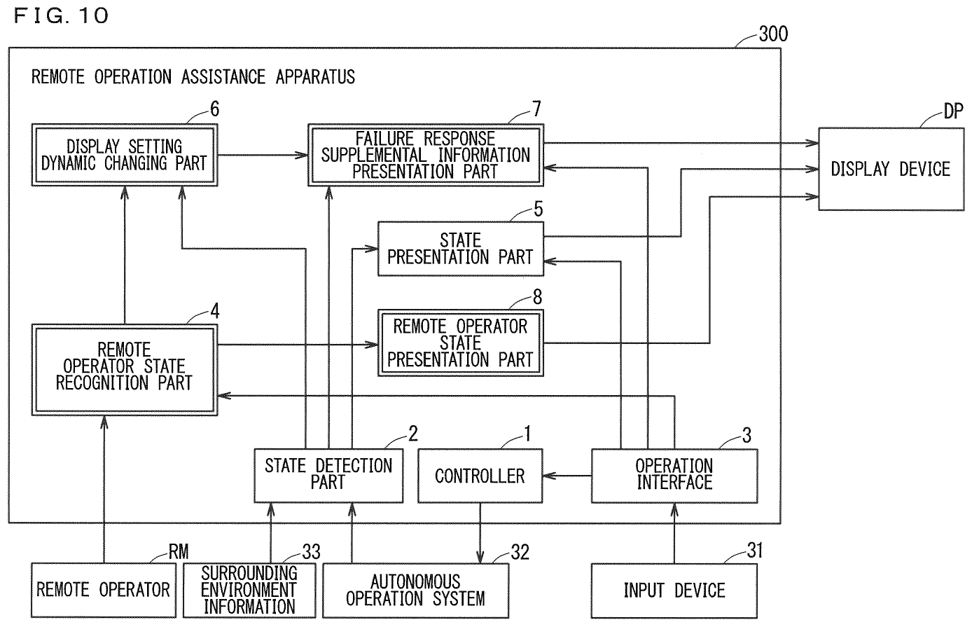

FIG. 10 is a block diagram illustrating a configuration of a remote operation assistance apparatus 300 according to an embodiment 3 in the present disclosure. The remote operation assistance apparatus 300 basically has the same configuration as the remote operation assistance apparatus 200 illustrated in FIG. 8. However, in the remote operation assistance apparatus 300, the display setting dynamic changing part 6 has a function of obtaining the information of the autonomous operation system 32 such as information of a sensor mounted to the autonomous operation system 32, for example, via the state detection part 2, and dynamically changes the display setting in accordance with the obtained information of the sensor. For example, when a temperature sensor obtains data in a range different from a normal time, processing such as an emphasized display is performed on a display item regarding the temperature sensor. Such processing can attract attention of the remote operator to a target sensor, and determination of necessity of the intervention operation can be supplemented.

### <Operation>

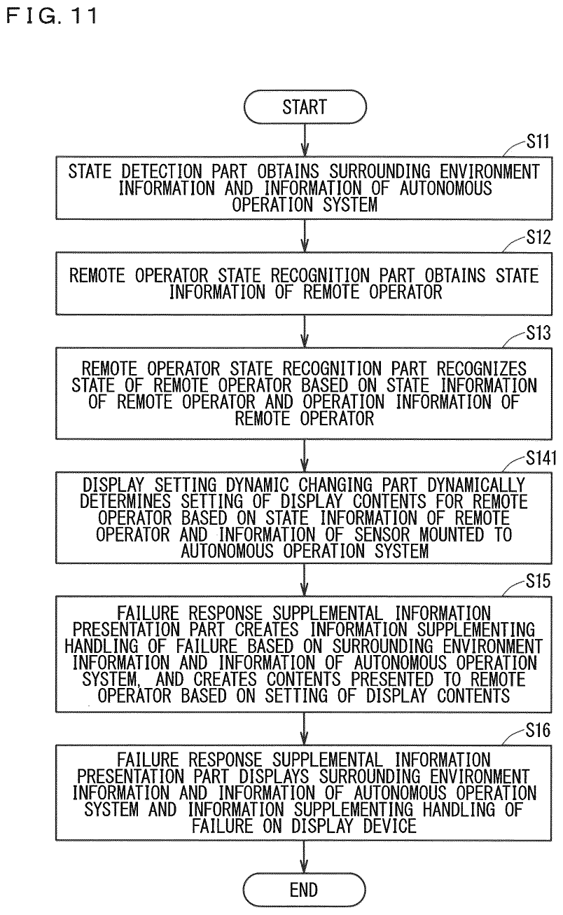

An operation of the remote operation assistance apparatus 300 is described next using a flow chart illustrated in FIG. 11. Steps S11 to S13, S15, and S16 in FIG. 11 are the same as Steps S11 to S13, S15, and S16 in the flow chart illustrated in FIG. 9; thus, the description is omitted.

In Step S141 subsequent to Step S13 in FIG. 11, the display setting dynamic changing part 6 dynamically determines the setting of the display content for the remote operator based on the state information of the remote operator and the information of the sensor mounted to the autonomous operation system 32.

### <Effect>

As described above, in the remote operation assistance apparatus 300 according to the embodiment 3, the display setting dynamic changing part 6 obtains the information of the sensor mounted to the autonomous operation system 32 and dynamically changes the display setting in accordance with the obtained information of the sensor. Thus, information supplementing the determination of the remote operator is increased, and the recognition load of the remote operator can be reduced.

### Embodiment 4

### <Configuration of Apparatus>

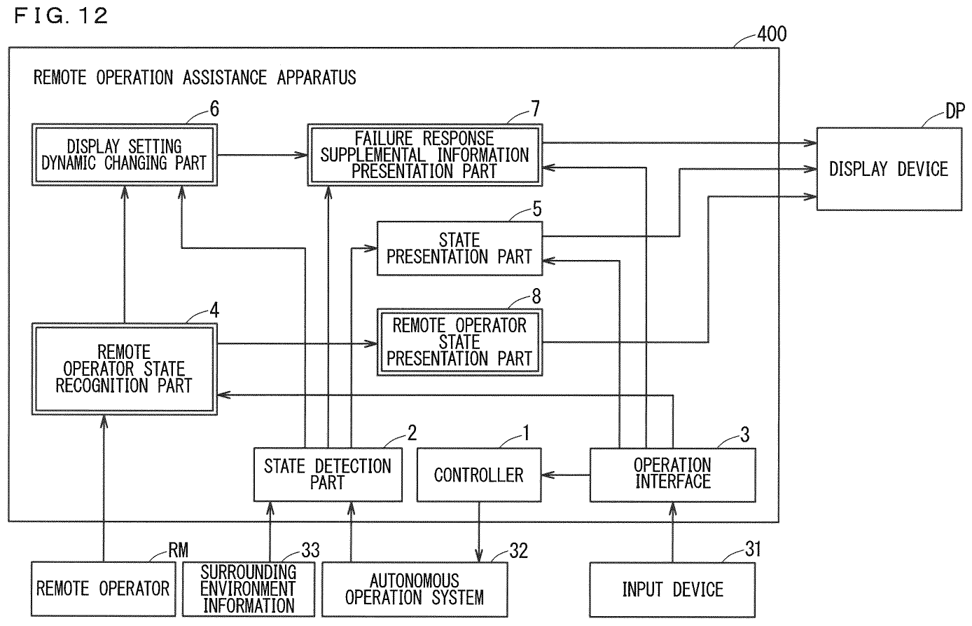

FIG. 12 is a block diagram illustrating a configuration of a remote operation assistance apparatus 400 according to an embodiment 4 in the present disclosure. The remote operation assistance apparatus 400 basically has the same configuration as the remote operation assistance apparatus 300 illustrated in FIG. 10. However, in the remote operation assistance apparatus 400, the remote operator state recognition part 4 has a function of obtaining viewpoint information of the remote operator and recognizing where the remote operator sees in a screen in the display device DP. The display setting dynamic changing part 6 has a function of changing the position of the display based on screen information of the screen which the remote operator recognized in the remote operator state recognition part 4 sees. The failure response supplemental information presentation part 7 reflects motion of a visual line of the remote operator on the screen of the display device DP which the remote operator sees to present the supplemental information.

The remote operator state recognition part 4 obtains viewpoint information of the remote operator by a visual line detection device such as an eye tracker and camera provided to a remote operation room in which the remote operation assistance apparatus 100 is disposed. Since the viewpoint information of the remote operator can be obtained from the eye tracker and the camera, the visual line of the remote operator is obtained, and it can be recognized where the remote operator sees in the screen of the display device DP. The screen information of the screen which the remote operator currently sees is added as the state information of the remote operator.

### <Operation>

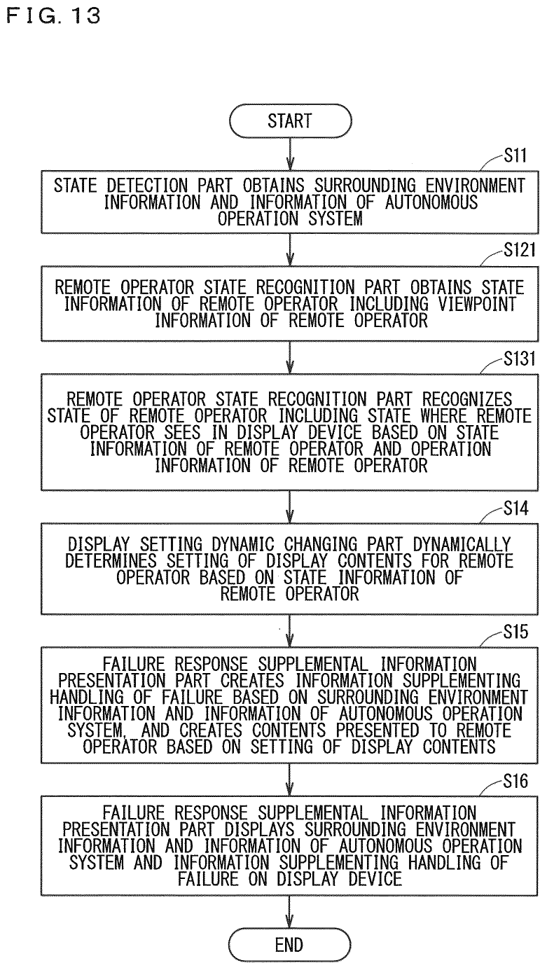

An operation of the remote operation assistance apparatus 400 is described next using a flow chart illustrated in FIG. 13. Steps S11 and S14 to S16 in FIG. 13 are the same as Steps S11 and S14 to S16 in the flow chart illustrated in FIG. 9; thus, the description is omitted.

In Step S121 subsequent to Step S11 in FIG. 13, the remote operator state recognition part 4 obtains the state information of the remote operator including the viewpoint information of the remote operator.

The remote operator state recognition part 4 recognizes the state of the remote operator including the state where the remote operator sees in the screen of the display device DP based on the state information of the remote operator and the operation information of the remote operator (Step S131).

### <Effect>

As described above, in the remote operation assistance apparatus 400 according to the embodiment 4, the remote operator state recognition part 4 recognizes where the remote operator sees in the screen of the display device DP, and the display setting dynamic changing part 6 change the position of the display based on the screen information of the screen which the remote operator recognized by the remote operator state recognition part 4 sees. Thus, the failure response supplemental information presentation part 7 can reflect the screen information of the display device DP which the remote operator sees on the display setting. When there are a plurality of screens which the remote operator sees in the display device DP, important information can follow and be displayed on the screen which the remote operator currently sees, and convenience of the remote operator can be increased.

### Embodiment 5

### <Configuration of Apparatus>

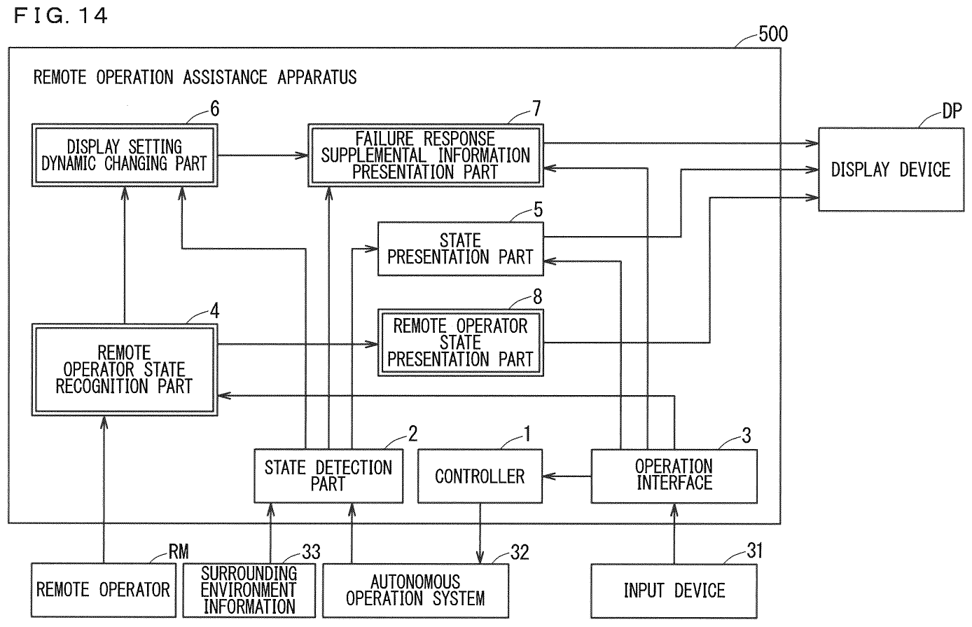

FIG. 14 is a block diagram illustrating a configuration of a remote operation assistance apparatus 500 according to an embodiment 5 in the present disclosure. The remote operation assistance apparatus 500 basically has the same configuration as the remote operation assistance apparatus 400 illustrated in FIG. 12. However, in the remote operation assistance apparatus 500, the remote operator state recognition part 4 has a function of recognizing where the remote operator sees in the screen of the display device DP and adding attention information of a focus of the remote operator in the intervention operation to the operation history. The display setting dynamic changing part 6 sets information of a target to be emphatically displayed using the attention information of the focus of the remote operator.

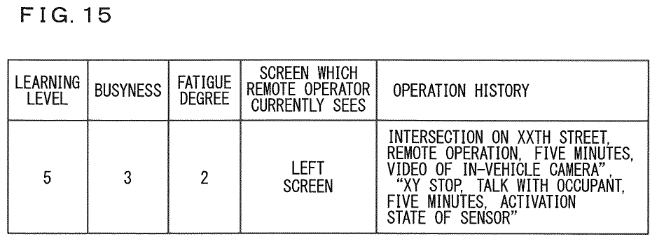

FIG. 15 illustrates an example of a state of the remote operator recognized by the remote operator state recognition part 4 by a table. FIG. 15 illustrates the learning level, the busyness, the fatigue degree, the screen which the remote operator currently sees, and the operation history. The learning level is 5, the busyness is 3, the fatigue degree is 2, and the screen which the remote operator currently sees is a left screen. “Intersection on XX^{th} street, remote operation, five minutes, video of in-vehicle camera” and “XY stop, talk with occupant, five minutes, activation state of sensor”, for example, are described as the operation history.

As described in the operation history in FIG. 15, the remote operator sees video of an in-vehicle camera in the screen of the display device DP and talks with an occupant at an XY stop in the remote operation of the autonomous operation system 32 at an intersection on an XX^{th} street, and focuses on an activation state of a sensor in the screen of the display device DP at that time. In this manner, the attention information of particular focus of the remote operator can be added to the operation history.

The display setting dynamic changing part 6 can reflect the attention information of the fucus of the remote operator in the intervention operation on the display setting. For example, when the same operation is needed, information of a focus in a similar case in the past such as an operation of seeing the video of the in-vehicle camera in the remote operation of the autonomous operation system 32 at the intersection of XX^{th} street is emphatically displayed, and confirmation of the activation state of the sensor at the XY stop is emphatically displayed. Thus, an operation to be performed by the remote operator can be presented, and convenience of the remote operator can be improved.

### <Operation>

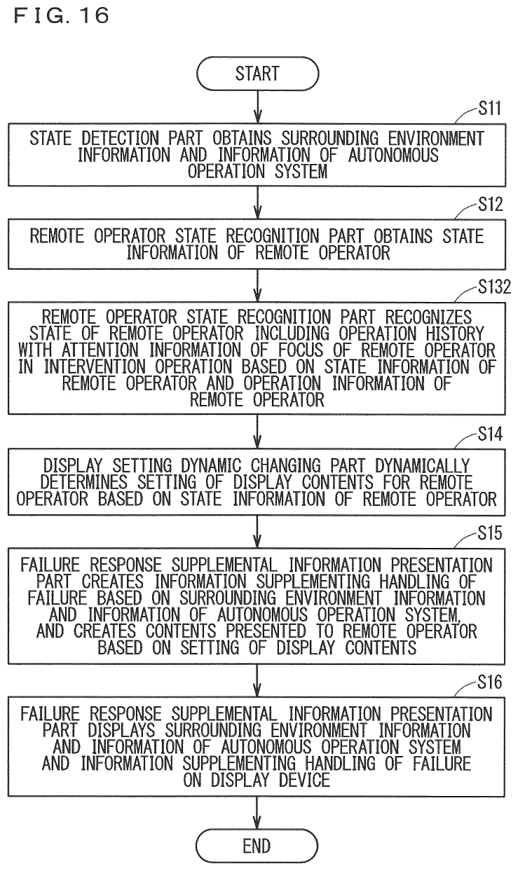

An operation of the remote operation assistance apparatus 500 is described next using a flow chart illustrated in FIG. 16. Steps S11, S12, and S14 to S16 in FIG. 16 are the same as Steps S11, S12, and S14 to S16 in the flow chart illustrated in FIG. 9; thus, the description is omitted.

In Step S132 subsequent to Step S12 in FIG. 16, the remote operator state recognition part 4 recognizes the state of the remote operator including the operation history including the information of the focus of the remote operator in the intervention operation based on the state information of the remote operator and the operation information of the remote operator.

### <Effect>

As described above, in the remote operation assistance apparatus 500 according to the embodiment 5, the remote operator state recognition part 4 adds the information of the focus of the remote operator in the intervention operation to the operation history, and the display setting dynamic changing part 6 reflects the information of the focus of the remote operator in the intervention operation on the display setting. Thus, convenience of the remote operator can be improved.

### <Hardware Configuration>

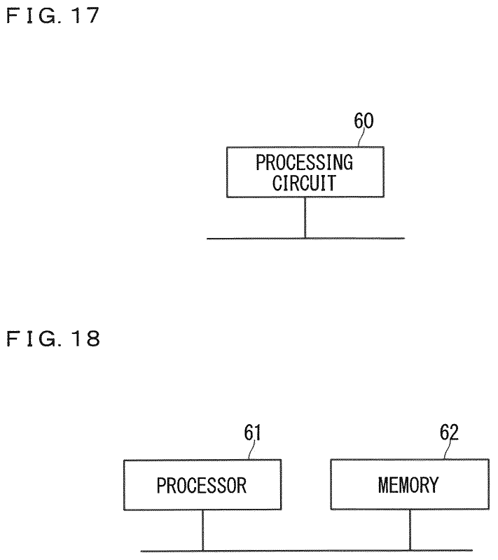

Each constituent element of the remote operation assistance apparatuses 100 to 500 according to the embodiments 1 to 5 described above can be made up using a computer, and is achieved when the computer executes a program. That is to say, the remote operation assistance apparatuses 100 to 500 are achieved by a processing circuit 60 illustrated in FIG. 17, for example. A processor such as a central processing unit (CPU) and a digital signal processor (DSP) is applied to the processing circuit 60, and the function of each part is achieved by executing the program stored in a storage device.

Dedicated hardware may be applied to the processing circuit 60. When the processing circuit 60 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 60.

In the remote operation assistance apparatuses 100 to 500, each of the functions of the constituent elements can be achieved by an individual processing circuit, and these functions can also be collectively achieved by one processing circuit.

FIG. 18 illustrates a hardware configuration in a case where the processing circuit 60 is made up using a processor. In this case, the function of each part of the remote operation assistance apparatuses 100 to 500 is achieved by a combination with software etc. (software, firmware, or software and firmware). The software etc. is described as a program and is stored in a memory 62. A processor 61 functioning as the processing circuit 60 reads out and executes a program stored in the memory 62 (storage device), thereby achieving the function of each part. That is to say, this program is deemed to make a computer execute a procedure or a method of the constituent elements of the remote operation assistance apparatuses 100 to 500.

Herein, the memory 62 may be a non-volatile or volatile semiconductor memory such as a RAM, a ROM, a flash memory, an erasable programmable read only memory (EPROM), or an electrically erasable programmable read only memory (EEPROM), a hard disk drive (HDD), a magnetic disc, a flexible disc, an optical disc, a compact disc, a mini disk, a Digital Versatile Disc (DVD), and a drive apparatus thereof, or any storage medium which is to be used in the future.

Described above is the configuration that the function of each constituent element of the remote operation assistance apparatuses 100 to 500 is achieved by one of the hardware and the software, for example. However, the configuration is not limited thereto, but also applicable is a configuration of achieving some constituent elements of the remote operation assistance apparatuses 100 to 500 by dedicate hardware, and achieving the other some constituent elements by software, for example. For example, functions of some constituent elements can be achieved by the processing circuit 60 as the dedicated hardware and functions of the other some constituent elements can be achieved by the processing circuit 60 as the processor 61 reading out and executing the program stored in the memory 62.

As described above, the remote operation assistance apparatuses 100 to 500 can achieve each function described above by the hardware, the software, or the combination of them, for example.

Although the present disclosure is described in detail, the foregoing description is in all aspects illustrative and does not restrict the present disclosure. It is therefore understood that numerous modification examples can be devised without departing from the scope of the present disclosure.

In the present disclosure, each embodiment can be arbitrarily combined, or each embodiment can be appropriately varied or omitted within the scope of the disclosure.

1. A remote operation assistance apparatus temporarily operating an autonomous operation system which is autonomous operated from a remote location, comprising:
state detection circuitry detecting surrounding environment information of the autonomous operation system and information of the autonomous operation system;
an operation interface receiving input from a remote operator including an intervention operation of remotely controlling the autonomous operation system and outputting the input as operation information;
state presentation circuitry obtaining the surrounding environment information and the information of the autonomous operation system from the state detection circuitry and presenting the surrounding environment information and the information of the autonomous operation system to the remote operator;
remote operator state recognition circuitry obtaining state information of the remote operator and recognizing a state of the remote operator using the state information and the operation information obtained from the operation interface;
display setting dynamic changing circuitry dynamically determining setting of information presented to the remote operator in accordance with the state of the remote operator recognized in the remote operator state recognition circuitry and outputting the setting as display setting; and
failure response supplemental information presentation circuitry displaying supplemental information supplementing determination of the remote operator on a display device based on the display setting obtained from the display setting dynamic changing circuitry.

2. The remote operation assistance apparatus according to claim 1, wherein
the remote operator state recognition circuitry estimates a learning level of the remote operator on an operation, busyness of the remote operator, and a fatigue degree of the remote operator, and recognizes the learning level, the busyness, and the fatigue degree as the state of the remote operator.

3. The remote operation assistance apparatus according to claim 1, wherein
the display setting dynamic changing circuitry dynamically determines setting of form of the information and an amount of the information presented to the remote operator, and
the failure response supplemental information presentation circuitry adjusts the form of the information and an amount of information obtained from the display setting dynamic changing circuitry and displays the information on the display device.

4. The remote operation assistance apparatus according to claim 1, further comprising
remote operator state presentation circuitry transmitting the state of the remote operator recognized in the remote operator state recognition circuitry to the remote operator and transmitting a purpose of dynamically changing the display setting to the remote operator.

5. The remote operation assistance apparatus according to claim 1, further comprising
the display setting dynamic changing circuitry dynamically determines the display setting using the information of the autonomous operation system obtained from the state detection circuitry.

6. The remote operation assistance apparatus according to claim 1, wherein
the remote operator state recognition circuitry obtains viewpoint information of the remote operator, and recognizes where the remote operator sees in a screen of the display device, and
the display setting dynamic changing circuitry dynamically reflects screen information of the screen which the remote operator recognized in the remote operator state recognition circuitry sees on the display setting to make the supplemental information.

7. The remote operation assistance apparatus according to claim 1, wherein
the remote operator state recognition circuitry obtains viewpoint information of the remote operator, and recognizes where the remote operator sees in a screen of the display device and
recognizes screen information of the screen on which the remote operator focuses in the intervention operation as attention information, and
the display setting dynamic changing circuitry dynamically reflects the attention information of the remote operator recognized in the remote operator state recognition circuitry on the display setting to make the supplemental information.

8. The remote operation assistance apparatus according to claim 2, wherein
the remote operator state recognition circuitry calculates the learning level, the busyness, and the fatigue degree of the remote operator by mechanical learning by an artificial intelligence using the state information and the operation information as input information.

9. The remote operation assistance apparatus according to claim 8, wherein
the display setting dynamic changing circuitry dynamically determines the setting of the information presented to the remote operator by the mechanical learning by the artificial intelligence using the learning level, the busyness, and the fatigue degree of the remote operator calculated in the remote operator state recognition circuitry as input information.

10. The remote operation assistance apparatus according to claim 1, wherein
the remote operator state recognition circuitry estimates at least one of the busyness of the remote operator and the fatigue degree of the remote operator and recognizes the at least one of the busyness and the fatigue degree as the state of the remote operator.

11. The remote operation assistance apparatus according to claim 1, comprising
remote operator state presentation circuitry transmitting notification of the state of the remote operator recognized in the remote operator state recognition circuitry to the remote operator and notifying the remote operator of a purpose of change including a reason of change in dynamically changing the display setting.
